(19) United States
(12) Patent Application Publication
(10) Pub. No.: US 2006/0172043 A1
(43) Pub. Date: Aug. 3, 2006

(54) Article of manufacture and method for the packaging of food products

(76) Inventors: Jean M. Krebs, Houston, TX (US); Cynthia A. Saltzman, Houston, TX (US)

Correspondence Address: Jean M. Krebs, 2006 Hillside Oak Drive, Houston, TX, 77062, US

(21) Appl. No.: 11/047,297

(22) Filed: Jan. 31, 2005

(51) Int. Cl. A23B 7/148

(52) U.S. Cl. 426/106

(57) ABSTRACT

A food container has a geometric shape selected in response to dietary or nutritional guidelines. The food container is divided into compartments based on a number of desired servings or proportions of different food groups. The compartments are sized and arranged in response to the dietary or nutritional guidelines.

### BACKGROUND OF THE INVENTION

### Technical Field of the Invention

This application relates to containers, and in particular, to a food container having compartments.

Recent studies indicate that obesity is increasingly becoming a significant health issue. See, e.g., Obesity Research November 2004; 12 Supplement 2:88S-101S and JAMA Jun. 16, 2004; 291(23):2847-50. An improper balance of food selections in an individual's daily diet may contribute to weight problems of the individual. On Apr. 28, 1992 the U.S. Department of Agriculture (USDA) published a food guide pyramid, for public use as a dietary aid to better control and monitor individual food consumption. The food guide pyramid disclosed three essential elements of a healthy diet: proportion, moderation, and variety. See U.S. Pat. No. 6,431,873, entitled “Food Group Monitoring Apparatus” and issued to Flagg on Aug. 13, 2002, the subject matter of which is hereby incorporated by reference. Even when individuals know what nutritional foods to eat, individuals do not necessarily select and consume those foods. In particular, individuals may select an improper balance of food selections because properly balanced foods are not widely available, are not easily prepared, or are not available as prepackaged foods.

### SUMMARY OF THE INVENTION

In accordance with the present invention, an article of manufacture and method for the packaging of food products is disclosed.

In particular, in one embodiment of the disclosed invention a container for food products shaped as a polyhedron is disclosed. The container includes at least one exterior sidewall and at least one interior sidewall separating the container into at least two compartments. The at least one interior sidewall is positioned relative to the at least one exterior side wall such that the relative size of the two compartments is related to the portions of at least two food products recommended by at least one dietary or nutritional guideline. The container includes a material in contact with the at least one exterior sidewall and the at least one interior sidewall, the material forming a first surface. The container also includes a flexible film in contact with the at least one exterior sidewall and the at least one interior sidewall, the flexible film forming a second surface.

In a second embodiment of the present invention, a method of packaging food products is disclosed. The method includes forming a food container shaped as a polyhedron, wherein at least one face of the polyhedron is in a shape selected in response to at least one nutritional or dietary guideline. The method also includes forming a plurality of compartments in such food container, wherein the number of such compartments are related to the amount of food recommended by the at least one nutritional or dietary guideline.

Another embodiment of the present invention discloses a container for food products having a plurality of compartments. Each of the plurality of compartments is associated with at least one connector operable to physically couple the compartment to at least one of the other of the plurality of compartments.

Additional embodiments of the disclosed invention are described in the detailed description provided below.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a one-dimensional view of the layout of a food container arranged in accordance with the teachings of an embodiment of the present invention;

FIG. 2 is a top-down view of the layout of a particular geometric shape of a food container formed in accordance with the teachings of an embodiment of the present invention;

FIG. 3 is a perspective view of a food container showing physical features of the food container formed in accordance with the teachings of an embodiment of the present invention;

FIG. 4 is a perspective view of a food container formed in accordance with the teachings of an embodiment of the present invention that illustrates the modular nature of the food container;

FIG. 5 is a perspective view of a food container formed in accordance with the teachings of an embodiment of the present invention that illustrates examples of food to be included within the food container;

FIG. 6 is a perspective view of a food container formed in accordance with the teachings of an embodiment of the present invention that illustrates separately packaged food products to be combined into a larger food container; and

FIG. 7 is a perspective view of a lunch box formed according to the teachings of the present invention.

### DETAILED DESCRIPTION OF THE INVENTION

FIG. 1 illustrates one embodiment of a representation of a food container 100 formed according to the teachings of the present invention. Food container 100 may be formed from plastic or from any other material suitable for sanitary food-contact applications. Food container 100 may be formed in any three dimensional shape. For example, food container 100 may have one face shaped like a triangle as illustrated in FIG. 1. Such a triangular shape would correspond to the current USDA nutritional guidelines with respect to balancing portions of different food groups. Alternatively, food container 100 could have one face formed in the shape of a square, pentagon, hexagon, or other shape, could be a polyhedron of any suitable number of sides such as a pyramid, frustum, or any other three-dimensional geometric object, or could be any other suitable shape or design.

The shape of food container 100 may correspond to current or future USDA nutritional or dietary guidelines or any other nutritional guidelines or models established by any agency, organization, industry, or company. For example, a diet for diabetic or high blood pressure consumers can be adapted to form a food container 100 of a particular shape or configuration. Such food container 100 need not correspond to current nutritional or dietary guidelines in the United States. For example, food container 100 could have one surface shaped like a rainbow like the Canadian nutrition logo with different rays corresponding to different food groups or a pagoda such as the Japanese nutrition logo with different levels of the pagoda corresponding to different food groups. Other embodiments of food container 100 may correspond to a tree in shape with different branches being devoted to different food groups.

Although not illustrated herein, in one embodiment food container 100 may be a cylinder or other three-dimensional shape having a circle or oval as one outer surface. Such a circular or oval shape has many advantages. For example, a circle allows any proportional division of recommended dietary foods to meet any nutritional or dietary guideline. For example, a guideline that recommends 40% grains, 20% protein sources, and 40% fruit and vegetables can easily be accommodated in such a cylinder or other three-dimensional container having a circular or oval surface. In fact, any dietary or nutritional guideline or plan that can be represented by a pie chart can easily be adapted to such a container.

Food container 100 includes a plurality of compartments 110, 120a, 120b, 130a, 130b, 140a, 140b, 140c, and 140d for holding food products. Compartments 110 through 140d are recessed areas in food container 100 forming a three dimensional space suitable for holding food products. Compartments 110 through 140d may be sized, shaped, and positioned and be of such number as to correspond to recommended diets or nutritional portions of different types of food as established by any agency, organization, industry, or company. For example, compartments 110 through 140d may correspond to the levels of a pyramid, the branches of a tree, or the rays of a rainbow. Compartments 110 through 140d may be of different or similar shape, dimensions, and volume relative to each other. For example, although illustrated as separate compartments, compartments 140a through 140d may instead be one single compartment suitable for holding bread. Compartment 330a and 330b may be suitable for holding lettuce and celery sticks in one compartment and tomatoes in another compartment.

In practice, compartments 110 through 140d of food container 100 can be filled with any suitable food product. Such food products may include protein-based foods such as meat, tofu, fish, poultry, cheese, other dairy products, or peanut butter. Such food products may further include fruits and vegetables such as carrot sticks, celery, apples, oranges, tomatoes, and lettuce. Such food products may also include farinaceous foods or starches such as bread, crackers, chips, and pretzels. Additionally, such food products may include sauces, dressings, and other condiments and cookies, confectioneries, and other desserts. Food products included in food container 100 may also be further individually packaged. For example, pre-cut fruits may be included in a plastic bag and salad dressings may be included in a tearable package. Compartments 110 through 140d may also be filled with beverages or with non-food items such as plastic utensils and napkins.

In one embodiment corresponding to the current USDA nutritional guidelines, compartment 140a through 140d of container 100 is filled with grains, compartments 130a and 130b are filled with fruits and vegetables, compartments 120a and 120b are filled with dairy, meats, or beans, and compartment 110 is filled with a beverage, source of fat, or dessert. For example, although illustrated as separate compartments, compartments 140a through 140d may instead be one single compartment containing bread. Compartment 130a may hold lettuce and compartment 130b may hold tomato. Compartment 130c may hold celery sticks. Compartments 120a and 120b may hold sliced turkey and Swiss cheese, respectively. Compartment 110 may hold ranch dressing for the celery sticks, condiments for the sandwich, and a cookie for dessert. In various embodiments, the content of container 100 may change in response to whatever guidelines are used to select the food products included therein.

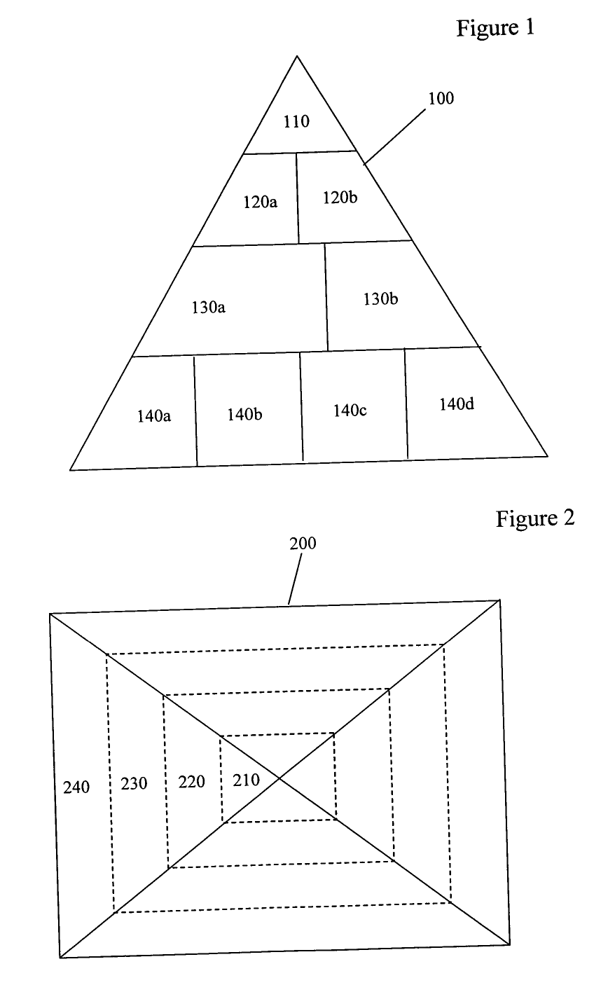

Now referring to FIG. 2, an alternative embodiment of a food container 200 formed according to the teachings of the present invention is illustrated. More particularly, the illustrated example of food container 200 is formed in a three-dimensional shape of a pyramid with a rectangular base. Food container 200 is provided as an illustration of a polyhedronal embodiment of a food container formed according to the teachings of the present invention. As discussed with regard to FIG. 1, any suitable shape or polyhedron can alternatively be utilized. Food container 200 includes sections 210, 220, 230, and 240. Each section 210, 220, 230, and 240 includes one or more food compartments. Due to the shape and configuration of the illustrated embodiment of food container 200, the volume of section 210 available to store food is considerably smaller than the volume of section 220, which is in turn considerably smaller than the volume of section 230. In the illustrated embodiment, section 240 has the largest volume available for food storage.

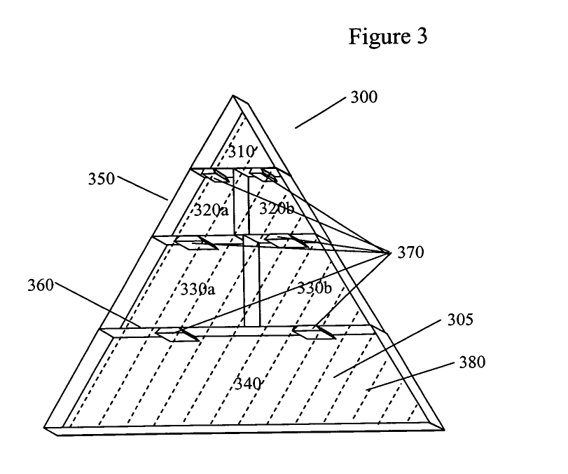

Now referring to FIG. 3, an additional embodiment of a food container 300 formed according to the teachings of the present invention is illustrated. Food container 300 includes compartments 310, 320a, 320b, 330a, 330b, and 340. Food container 300 has a bottom surface 305. The exterior of food container 300 has exterior side walls 350. Compartments 310 through 340 have interior sidewalls 360. Interior sidewalls 360 may be the different heights than the exterior side walls 350. However, in one embodiment interior side walls 360 are the same height as exterior side walls 350. In one embodiment, bottom surface 305, exterior side walls 350, and interior side walls 360 are made of plastic. Alternatively, bottom surface 305, exterior side walls 350, and interior side walls 360 may be made of aluminum, paper, cardboard, laminated paper, laminated cardboard, polycarbonate, or any other material suitable for sanitary food-contact applications.

A flexible film 380 may be affixed to the peripheral of food container 300 to form an airtight container. In such a manner, flexible film 380 forms another exterior surface of food container 300. In one embodiment, flexible film 380 is made of plastic and is translucent such that a consumer can see through it to view food included in compartments 310 through 340. Alternatively, flexible film 380 may be made of aluminum foil, wax paper, or any other material suitable for food-contact applications. Alternatively, flexible film 380 may instead be isolated from food included within food container 300 by another material or further packaging. In one embodiment, flexible film 380 hermetically seals compartments 310 through 340. For example, flexible film 380 may be a taut, flexible film adhered or otherwise applied across the top of food container 300 preventing spillage or seepage from one of compartments 310 to 340 to another or to the outside of food container 300. In such an embodiment, flexible film 380 may be glued to the tops of exterior sidewalls 350 and interior sidewalls 360. Alternatively, flexible film 380 may be adhered to the surface of exterior sidewalls 350 or interior sidewalls 360 using pressure, sonic or laser bonding or any other suitable adhesive, etch, or bonding technique or process.

In one embodiment, the interior sidewalls 360 of food container 300 also include connectors 370. Connectors 370 physically couple one or more of compartments 310 to 340 to one or more of other compartments 310 to 340. For example, as illustrated in FIG. 3, compartment 310 is coupled to each of compartments 320a and 320b using a connector 370. Likewise, in the illustrated embodiment, compartments 320a and 320b are respectively coupled to compartments 330a and 330b using connectors 370. In such embodiment, compartments 330a and 330b are each connected to compartment 340 using connectors 370.

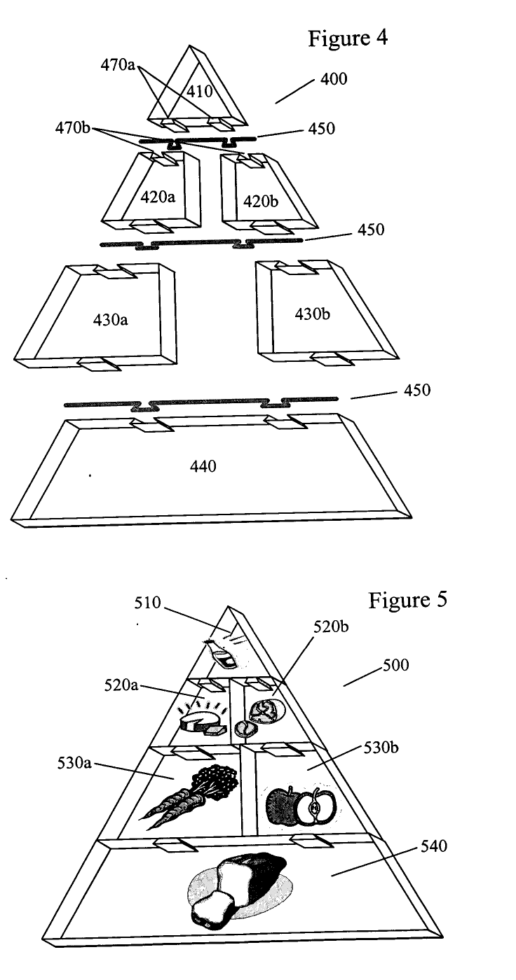

In one embodiment, connectors 370 may be slotted or slidable connections between interior sidewalls of adjacent compartments 310 to 340. For example, as further illustrated in FIG. 4, a compartment 410 of food container 400 has protruding or male connection elements 470a securable to receiving or female connection elements 470b by sliding connection elements 470a into connection elements 470b. Such a connection is sometimes referred to as a dovetail joint. A connector 370 may alternatively be another type of one or more connecting elements such as a clip, clasp, buckle, snap, Velcro™ strip, adhesive, or any other suitable fastener, bond, or physical coupling. In one embodiment, connection elements 470a and 470b each may be intermediately connected to a connection strip 450 positioned between connection elements 470a and 470b rather than being directly connected. In such a manner, connection strip 450 may increase the stability and structural integrity of food container 400. Connection strip 450 may include any suitable connections, fasteners, bonds, or couplings.

As illustrated in FIG. 4, the presence of connectors 370 such as connectors 470a and 470b allows food container 400 to be modular and configurable in different combinations. In particular, one or more types of food products can be individually selected by a manufacturer, distributor, retailer, or consumer (hereafter a “selector”) and combined with other types of food products. In such a manner, food products individually packaged as certain of compartments 410 through 440 may be combined with other food products individually packaged as other of compartments 410 through 440.

For example, a selector may have several choices of food products in containers shaped and sized like compartment 440, such as white bread, wheat bread, rye bread, pita bread, or a tortilla. Likewise, a selector may have several choices of food products in packaging shaped and sized like compartment 430a, such as celery sticks, carrot sticks, broccoli florets, cucumber slices, or a lettuce salad. A selector may have a choice of food products in packages shaped and sized like compartment 430b, such as a slice of lettuce, a slice of tomato, a slice of onion, a slice of bell pepper, slices of apple or orange. Similarly, a selector may have a choice of different kinds of sandwich meat and cheeses respectively packaged in the shape and size of compartments 420a and 420b. Finally, a selector may have a choice of different beverages, desserts, or condiments packaged in the shape and size of compartment 410. Upon selecting a combination of such food products, selector can then assemble compartments 410 through 440 containing such selected food products into an overall food container 400 using connectors 370 such as connectors 470a and 470b.

As is apparent from the above example, a selector may have a choice of several alternative food products that are in the same relative food group or nutritional category. More particularly, after combining the chosen food products from the above example in compartments 410 through 440 as food container 400, the selector will have assembled a combination of food products consistent with the nutritional guidelines of the USDA. In such a manner, the shape and size of food container 400 and compartments 410 through 440 and position of connectors 370 may be selected to enforce selections by a selector to ensure a balanced meal having the appropriate nutritional content. For example, a food container 400 could not be constructed of just beverages, desserts, and breads because the compartments 410 and 440 containing such food products could not be connected to form food container 400. A completed triangular or pyramid shaped food container 400 therefore ensures that a balanced meal is available to consumers.

Food container 400 may be priced by a manufacturer, retailer, distributor as a whole. Alternatively, compartments 410 through 440 may be individually priced. As discussed above, although a triangular or pyramidal structure of food container 400 is illustrated and discussed with regard to FIGS. 3 and 4, any other suitable shape, size, and configuration may be utilized depending on the particular dietary or nutritional guidelines, models, or recommendations being consulted.

FIG. 4 also illustrates the ease of manufacture and assembly of food packages that fit together to form food container 400. Food container 400 as well as the food containers disclosed in alternative embodiments can be manufactured using materials and manufacturing processing technologies well-known in the industry, including but not limited to methods of manufacturing associated with forming plastic containers, laminating cardboard, applying flexible films, and vacuum-based food packaging.

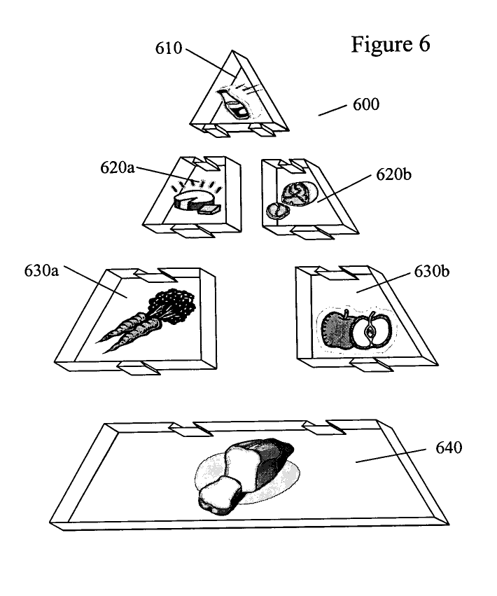

FIGS. 5 and 6 are further illustrations of embodiments of food containers implemented according to the present invention. In particular, FIG. 5 illustrates food container 500 that includes compartments 510, 520a, 520b, 530a, 530b, and 540, each of which is sized according to desired proportions and contain a food product as illustrated in the compartments of FIG. 5. FIG. 6 illustrates the same compartments as they would be individually packaged in compartments 610 through 640.

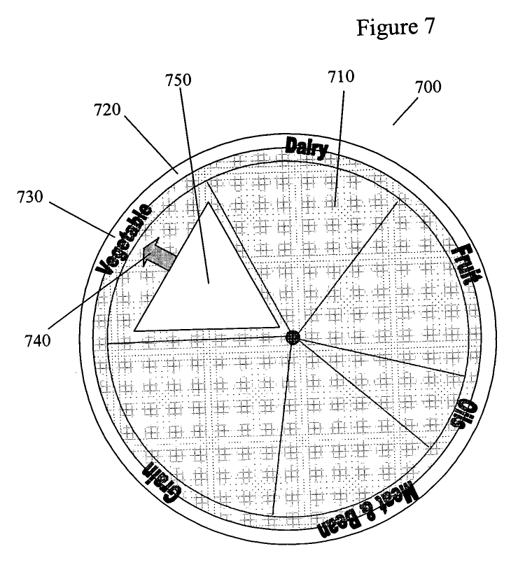

In yet another embodiment of the disclosed invention illustrated in FIG. 7, a lunch box 700 may be formed in a shape based on nutritional or dietary guidelines. Lunch box 700 may also be divided into compartments of size and position based on nutritional or dietary guidelines. For example, in one embodiment lunch box 700 is a reusable plastic container with one or more lids 710 over each compartment of a base 720 of lunch box 700. Alternatively, for purposes of this application, lunch box 700 may be any reusable or disposable container of any shape, size, or arrangement having a plurality of compartments or divisions where food items can be stored. Lid 710 may be attached to base 720 of lunch box 700 with clips, hinges, snaps, seals, or any other suitable fastener or juncture between lid 710 and base 720.

In one embodiment, lunch box 700 includes a dial-a-food-group™ feature, wherein a user of lunch box 700 can select a graphical or textual representation 730 of a food group on lid 710 or base 720 (hereafter “an indication”) of lunch box 700 by moving an arrow or other designator 740 on lid 710 of lunch box 700 to point to such representation. Such a dial-a-food-group™ feature may, for example, have an opening 750 in lid 710 of lunch box 700 that is located over a storage position which blocks access to food within lunch box 700 when the user of lunch box 700 does not wish to remove food. The user may rotate, slide, or otherwise move at least one portion of lid 710 to indicate the food group the user would like to access first in lunch box 700, such rotation, sliding, or movement resulting in the opening 750 being moved over a portion of the base 720 of lunch box 700, that allows access to any food stored in the compartment or division of lunch box 700 associated with the food group representation selected.

Such a dial-a-food-group™ feature has the advantage of not only ensuring that lunch box 700 can be organized such that all food groups are represented in separate compartments or divisions, but that also young consumers learn which foods correspond to which food groups while accessing lunch box 700. Although explained herein with regard to a lunch box embodiment, the dial-a-food-group™ feature may be implemented in any food container described herein. In such embodiments, the dial-a-food-group™ feature may be an opening in a lid that is positioned over a flexible film such as the one described above that covers an underlying compartment of the food container to ensure that the food remains fresh, safe, and sanitary.

Although the invention has been described in detail, it will be apparent that the invention is capable of numerous modifications and variations, without departing from the spirit and scope of the invention. In particular, the container may be modified according to the then current nutritional model or dietary guidelines of the USDA food guidance system or any other agency, organization, or industry group.

What is claimed is:

1. A container for food products, wherein the container comprises:
at least one exterior sidewall;
at least one interior sidewall separating the container into at least two compartments, wherein the at least one interior sidewall is positioned relative to the at least one exterior side wall such that the relative size of the two compartments is related to an amount of at least two food products that is recommended by at least one dietary or nutritional guideline;
a material in contact with the at least one exterior sidewall and the at least one interior sidewall, the material forming a first surface; and
a flexible film in contact with the at least one exterior sidewall and the at least one interior sidewall, the flexible film forming a second surface.

2. The container of claim 1, wherein at least one surface of the container is in the shape of a triangle.

3. The container of claim 1, wherein at least one surface of the container is in the shape of a trapezoid.

4. The container of claim 1, wherein at least one surface of the container is in the shape of a circle.

5. The container of claim 1, wherein the container is a polyhedron.

6. The container of claim 1, wherein the container is shaped as a pyramid.

7. The container of claim 1, wherein the container is shaped as a frustum.

8. The container of claim 1, wherein the container is shaped as a cylinder

9. The container of claim 1, wherein the shape of the container corresponds to a relationship between a number of portions of different foods recommended by the at least one dietary or nutritional guideline.

10. The container of claim 1, wherein the material is a polymer.

11. The container of claim 1, wherein the number of the at least two compartments is selected in response to the at least one dietary or nutritional guideline.

12. The container of claim 1, wherein the size of each of the at least two compartments is selected in response to the at least one dietary or nutritional guideline.

13. A method of packaging food products, the method comprising:
forming a food container, wherein at least one surface of the food container is in a shape selected in response to at least one nutritional or dietary guideline; and
forming a plurality of compartments in the food container, wherein the number of the plurality of compartments are related to the amount of a food recommended by the at least one nutritional or dietary guideline.

14. The method of claim 13, wherein forming the food container comprises forming the food container with the at least one surface having the shape of a triangle.

15. The method of claim 13, wherein forming the food container comprises forming the food container with the at least one surface having the shape of a trapezoid.

16. The method of claim 13, wherein forming the food container comprises forming the food container with the at least one surface having the shape of a circle.

17. The method of claim 13, wherein forming the food container comprises forming the food container in the shape of a polyhedron.

18. The method of claim 13, wherein forming the food container comprises forming the food container in the shape of a pyramid.

19. The method of claim 13, wherein forming the food container comprises forming the food container in the shape of a frustum.

20. The method of claim 13, wherein forming the food container comprises forming the food container in the shape of a cylinder.

21. The method of claim 13, and further comprising placing a food in at least one of the plurality of compartments.

22. The method of claim 13, wherein there are at least three of the plurality of compartments and wherein the method further comprises:
placing a grain-based food into at least one of the at least three compartments;
placing a fruit or vegetable food into at least one of the at least three compartments; and
placing a protein product into at least one of the at least three compartments.

23. The method of claim 13, and further comprising applying a flexible film overlying the plurality of compartments, the flexible film being suitable for food-contact applications.

24. The method of claim 22, wherein applying a flexible film further includes applying a translucent film overlying the plurality of compartments.

25. A container for food products, wherein the container comprises:
a first food package containing a first type of food;
a second food package containing a second type of food; and
at least one connector operable to physically couple the first food package and the second food package.

26. The container of claim 25, wherein the at least one connector has a first portion associated with the first food package and a second portion associated with the second food package.

27. The container of claim 25, wherein the at least one connector has a first portion associated with the first food package and a second portion associated with the second food package and wherein the two food packages are operable to be physically coupled by the first portion engaging the second portion.

28. The container of claim 25, wherein the at least one connector is Velcro™.

29. The container of claim 25, wherein the at least one connector is a dovetail joint.

30. The container of claim 25, wherein the at least one connector is slidable.

31. The container of claim 25, wherein the container is formed in a shape selected in response to at least one nutritional or dietary guideline.

32. The container of claim 25, wherein the size of the first and second food packages is determined in response to proportions of food recommended by at least one nutritional or dietary guideline.

33. A method of packaging a food product, wherein the method comprises:
selecting a first food package containing a first type of food;
selecting a second food package containing a second type of food;
physically coupling the first food package to the second food package.

34. The method of claim 33, wherein physically coupling the first food package to the second food package comprises attaching the first food package to a connection strip and attaching the second food package to the connection strip.

35. The method of claim 33, wherein selecting the first food package further comprises selecting the first food package from a plurality of food packages, the plurality of food packages including at least two types of food.

36. The method of claim 35, wherein physically coupling the first food package to the second food package further comprises physically coupling the first food package to the second food package in response to the first food package being a first type of food and not a second type of food.

37. A container for food products comprising a plurality of compartments, each of the plurality of compartments corresponding to a food product identified in such nutritional guidelines.

38. The container of claim 37, wherein the container is formed in a shape corresponding to a nutritional guideline as to the amount of a plurality of food products recommended for consumers.

39. The container of claim 37, wherein the container includes at least one surface in the shape of a triangle.

40. The container of claim 37, wherein the container includes at least one surface in the shape of a circle.

41. The container of claim 37, wherein the container is formed in the shape of a polyhedron.

42. The container of claim 37, wherein the container is in the shape of a cylinder.

43. The container of claim 37, wherein the container includes a lid and a base, the lid including an opening, the lid being operable to be movable such that the opening changes position relative to the base.

44. The container of claim 43, wherein the base is marked with at least one indication of a particular type of food, the indication being associated with a particular compartment of the container.

45. The container of claim 44, wherein the indication is operable to be visible through the lid when the opening is over the portion of the base marked with the indication.

46. The container of claim 45, wherein the particular compartment is accessible through the opening in response to the opening being over the portion of the base marked with the indication.

47. A container for food products having a plurality of compartments, each of the plurality of compartments being associated with at least one connector operable to physically couple the compartment to at least one of the other of the plurality of compartments.

48. The container of claim 47, wherein each of the plurality of compartments has a shape and wherein the plurality of compartments are operable to form a predetermined shape of the food container when they are physically coupled together in an arrangement determined in response to at least one nutritional or dietary guideline.

49. The container of claim 47, wherein the at least one connector is configured relative to the exterior surface of at least one of the plurality of compartments such that the plurality of compartments are operable to be physically coupled in an arrangement determined in response to at least one nutritional or dietary guideline.

50. The container of claim 47, wherein each of the plurality of compartments includes food selected from at least two types of food, and the position of the at least one connector is operable to prevent one of the plurality of compartments having one of the two types of food is not physically coupled to another one of the plurality of compartments having the same type of food.

51. A lunch box having a plurality of compartments, each compartment corresponding to a food group of a nutritional or dietary guideline.

52. The lunch box of claim 51, wherein the shape of the lunch box corresponds to a nutritional or dietary guideline.

53. The lunch box of claim 51, wherein the lunch box includes a lid, the lid having an opening, the opening being operable to be moved relative to the lunch box to allow food to be removed from the lunch box when the opening is positioned over a portion of the lunch box, the portion of the lunch box being associated with a particular food group.

54. The lunch box of claim 51, wherein the lunch box includes a lid and a base, the lid including an opening, the lid being operable to be movable such that the opening changes position relative to the base.

55. The lunch box of claim 54, wherein the base is marked with at least one indication of a particular type of food, the indication being associated with a particular compartment of the lunch box.

56. The lunch box of claim 55, wherein the indication is operable to be visible through the lid when the opening is over the portion of the base marked with the indication.

57. The lunch box of claim 56, wherein the particular compartment is accessible through the opening in response to the opening being over the portion of the base marked with the indication.
